(19) United States
(12) Patent Application Publication
(10) Pub. No.: US 2025/0353329 A1
(43) Pub. Date: Nov. 20, 2025

(54) LEAF SPRING SUPPORT FOR SPOKE STRUCTURE FOR NON-PNEUMATIC TIRE

(71) Applicant: Bridgestone Americas Tire Operations, LLC, Nashville, TN (US)

(72) Inventors: Benjamin E. Rimai, Copley, OH (US); Prashant Kumar, Stow, OH (US)

(21) Appl. No.: 18/867,707

(22) PCT Filed: Jun. 1, 2023
(86) PCT No.: PCT/US2023/067730

§ 371 Date: Nov. 20, 2024

Related U.S. Application Data
(60) Provisional application No. 63/353,226, filed on Jun. 17, 2022.

(51) Int. Cl. B60C 7/14

(52) U.S. Cl. CPC B60C 7/146

(57) ABSTRACT

A non-pneumatic tire includes a lower ring having a first diameter and an upper ring having a second diameter. The upper ring is substantially coaxial with the lower ring. A support structure connects the lower ring to the upper ring. The support structure is made up of a plurality of spokes. The support structure is arranged and configured so that adjacent spokes of the plurality of spokes contact one another upon the occurrence of a high impact event.

### FIELD OF INVENTION

The present disclosure relates to a non-pneumatic tire. More particularly, the present disclosure relates to a non-pneumatic tire having a support structure with spokes that are designed to contact one another during the occurrence of a high impact event.

### BACKGROUND

Various tire constructions have been developed that enable a tire to run in an uninflated or underinflated condition. Non-pneumatic tires do not require inflation, while “run flat tires” may continue to operate after being punctured and becoming partially or completely depressurized, for extended periods of time and at relatively high speeds. Non-pneumatic tires may include support structure, such as spokes or webbing, that connects a lower ring to an upper ring. In some non-pneumatic tires, a circumferential tread may be attached to the upper ring of the tire.

The circumferential tread may contain a tread band. The tread band may be a single layer of material or a multi-layer band. Such tread bands may also be referred to as a shear band, a shear element, or a thin annular high strength band element. When used in a non-pneumatic tire, or in a pneumatic tire in a partially pressurized or unpressurized state, the shear element acts as a structural compression member. When used in a fully pressurized pneumatic tire, the shear element acts as a tension member.

Tire design, for both pneumatic and non-pneumatic tires, involves the balancing of many factors including, but not limited to, load capacity, handling, and ride quality. Regardless of the balance that is selected between these factors, non-pneumatic tires must be durable and be able to withstand high impact events, such as hitting a curb, pothole, or other obstruction or road imperfection.

### SUMMARY OF THE INVENTION

In one embodiment, a non-pneumatic tire includes a lower ring having a first diameter and an upper ring having a second diameter. The upper ring is substantially coaxial with the lower ring. A support structure connects the lower ring to the upper ring. The support structure is made up of a plurality of spokes. The plurality of spokes are arranged into a first spoke group and a second spoke group that is axially spaced from the first spoke group. Each one of the plurality of spokes includes a first end connected to the lower ring and a second end connected to the upper ring. A transition portion is located between the first end and the second end. A helper spring nests with the transition portion of the spoke.

In another embodiment, a method of manufacturing a non-pneumatic tire includes providing a lower ring having a first diameter and an upper ring having a second diameter that is greater than the first diameter. A plurality of spokes are formed. Each spoke extends between a first end and a second end. Each spoke has a transition portion between the first end and the second end. Each spoke has a helper spring nesting with the transition portion. The plurality of spokes are arranged into a first spoke group and a second spoke group that is axially spaced from the first spoke group. The lower ring is connected to the upper ring with the first spoke group and the second spoke group.

In yet another embodiment, a non-pneumatic tire includes a lower ring having a first diameter and an upper ring having a second diameter. The upper ring is substantially coaxial with the lower ring. A support structure connects the lower ring to the upper ring. The support structure is made up of a plurality of spokes. Each one of the plurality of spokes is provided with a helper spring nesting with a curved portion of the spoke. The helper spring is arranged and configured to reduce stress in an associated spoke.

### BRIEF DESCRIPTION OF DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a side view of one embodiment of a non-pneumatic tire,

FIG. 2 is another side view of the non-pneumatic tire of FIG. 1,

FIG. 3 is a sectional view along 3-3 of FIG. 1,

FIG. 4 is a detail view of Area A of FIG. 1,

FIG. 5 is a detail view of Area A of FIG. 1 with some features removed for clarity,

FIG. 6 is a detail view of a single spoke that is used in the non-pneumatic tire of FIG. 1,

FIG. 7 is a side view of part of the non-pneumatic tire of FIG. 1 when the tire is on a flat surface and carrying a normal load,

FIG. 8 is a side view of part of the non-pneumatic tire of FIG. 1 when the tire is on a flat surface and carrying a normal load, with some features removed for clarity,

FIG. 9 is a side view of part of the non-pneumatic tire of FIG. 1 when the tire is on an uneven surface,

FIG. 10 is a side view of part of the non-pneumatic tire of FIG. 1 when the tire is on an uneven surface, with some features removed for clarity,

FIG. 11 is a flow chart showing a method of manufacturing the non-pneumatic tire of FIG. 1,

FIG. 12 is another embodiment of a spoke for a non-pneumatic tire,

FIG. 12a is an end view of the spoke of FIG. 12 along I-I,

FIG. 13 is a side view of part of an alternative embodiment of a non-pneumatic tire,

FIG. 14 is a detail view of a single spoke and helper spring that is used in the non-pneumatic tire of FIG. 13,

FIG. 14a is a view along A-A of FIG. 14,

FIG. 15 is a detail view of part of FIG. 14,

FIGS. 16a-16c are variations on part of the helper spring,

FIGS. 17a-17c are graphs illustrating performance metrics exhibited by the variations of the helper spring shown in FIGS. 16a-16c, respectively,

FIGS. 18a-18d are further variations of part of the helper spring,

FIG. 19 is a variation of the spoke arrangement shown in FIGS. 13-15, and

FIG. 20 is another variation of the spoke arrangement shown in FIGS. 13-15.

### DETAILED DESCRIPTION

The following includes definitions of selected terms employed herein. The definitions include various examples or forms of components that fall within the scope of a term and that may be used for implementation. The examples are not intended to be limiting. Both singular and plural forms of terms may be within the definitions.

“Axial” and “axially” refer to a direction that is parallel to the axis of rotation of a tire.

“Circumferential” and “circumferentially” refer to a direction extending along the perimeter of the surface of the tread perpendicular to the axial direction.

“Radial” and “radially” refer to a direction perpendicular to the axis of rotation of a tire.

“Tread” as used herein, refers to that portion of the tire that comes into contact with the road or ground under normal inflation and normal load.

While similar terms used in the following descriptions describe common tire components, it should be understood that because the terms carry slightly different connotations, one of ordinary skill in the art would not consider any one of the following terms to be purely interchangeable with another term used to describe a common tire component.

Directions are stated herein with reference to the axis of rotation of the tire. The terms “upward” and “upwardly” refer to a general direction towards the tread of the tire, whereas “downward” and “downwardly” refer to the general direction towards the axis of rotation of the tire. Thus, when relative directional terms such as “upper” and “lower” or “top” and “bottom” are used in connection with an element, the “upper” or “top” element is spaced closer to the tread than the “lower” or “bottom” element. Additionally, when relative directional terms such as “above” or “below” are used in connection with an element, an element that is “above” another element is closer to the tread than the other element.

The terms “inward” and “inwardly” refer to a general direction towards the equatorial plane of the tire, whereas “outward” and “outwardly” refer to a general direction away from the equatorial plane of the tire and towards the side of the tire. Thus, when relative directional terms such as “inner” and “outer” are used in connection with an element, the “inner” element is spaced closer to the equatorial plane of the tire than the “outer” element.

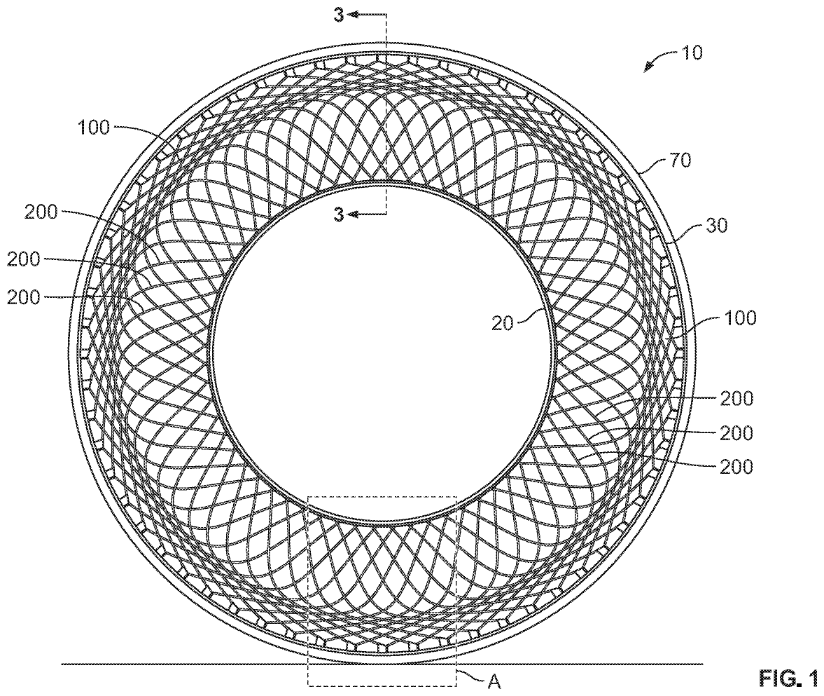

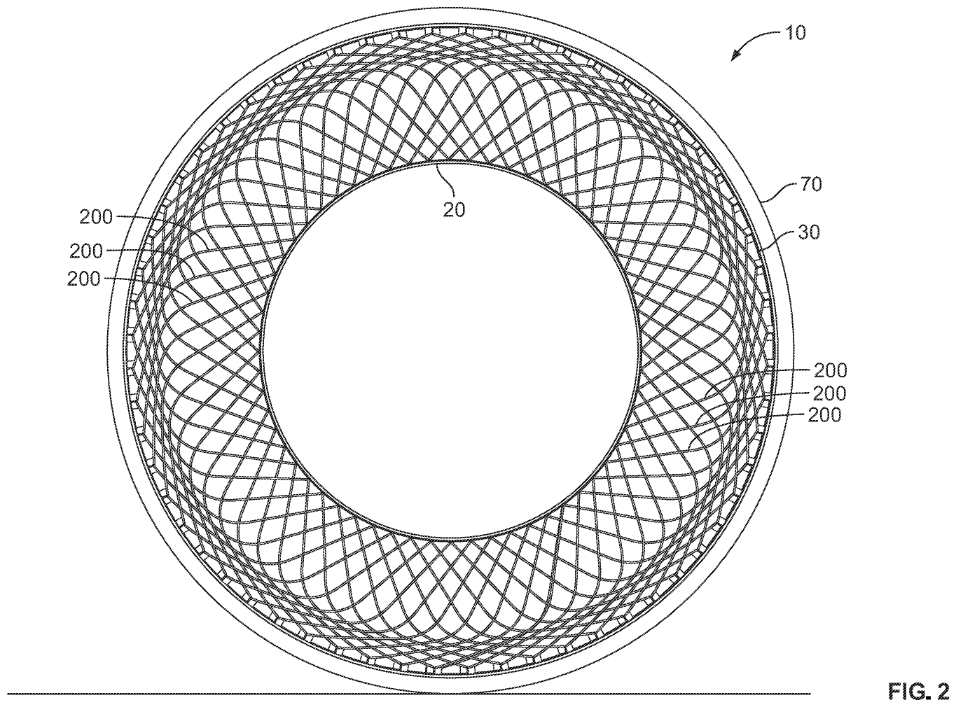

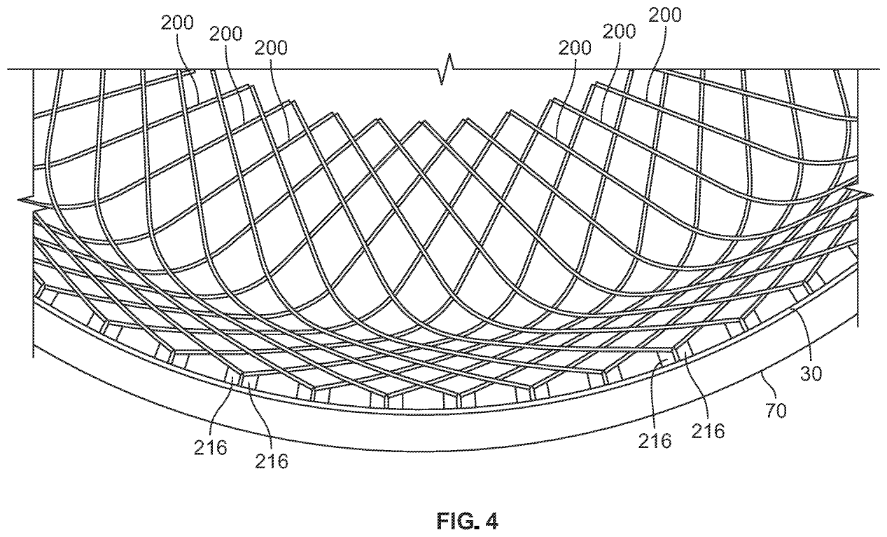

FIGS. 1-5 illustrate one embodiment of a non-pneumatic tire 10. The non-pneumatic tire 10 is merely an exemplary illustration and is not intended to be limiting. In the illustrated embodiment, the non-pneumatic tire 10 includes a generally annular lower ring 20. The lower ring 20 may engage a vehicle hub (not shown) for attaching the tire 10 to a vehicle. The lower ring 20 has an internal surface 23 and an external surface 24, and may be made of a polymeric material, an elastomeric material, a metal, a composite made up of polymers reinforced with glass or carbon fibers, or any other desired material or combination of materials.

The non-pneumatic tire 10 further includes a generally annular upper ring 30. The upper ring 30 has a diameter that is greater than a diameter of the lower ring 20, and is substantially coaxial with the lower ring 20. The upper ring 30 has an internal surface 33 and an external surface 34, and may be made out of a polymeric material, an elastomeric material, a metal, a composite made up of polymers reinforced with glass or carbon fibers, or any other desired material or combination of materials. A circumferential tread 70 is attached to the external surface 34 of the upper ring 30. The circumferential tread 70 may be attached to the upper ring 30 adhesively, mechanically, or by any other desired arrangement.

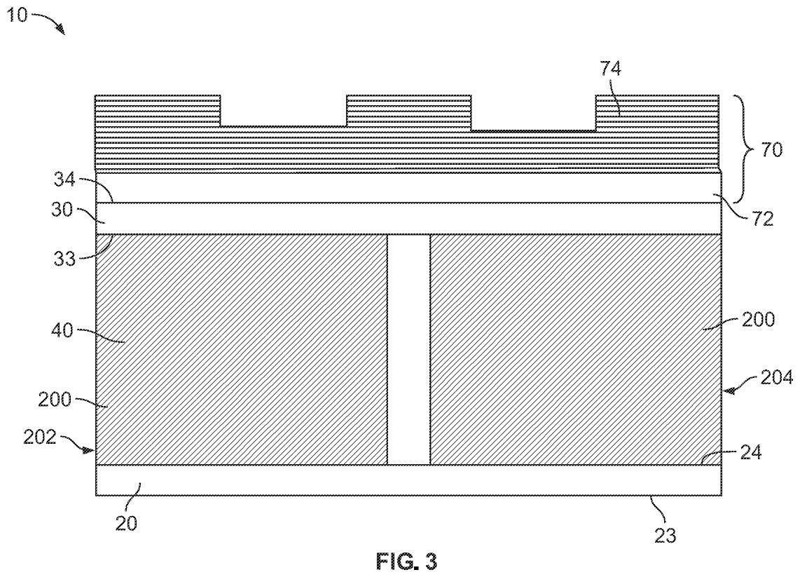

As shown in FIG. 3, the circumferential tread 70 includes a tread band 72 and a tread layer 74. The tread band 72 and the tread layer 74 may be made of out of the same material or different material. The tread layer 74 may be made out of rubber, and may include tread elements (not shown) such as grooves, ribs, blocks, lugs, sipes, studs, or any other desired tread elements. The tread band may include a filament assembly.

In the illustrated embodiment, the tread band 72 is shown as a single layer. In alternative embodiments, the tread band may be a multi-layer band. Such multi-layer tread bands may include one or more layers of substantially inextensible material. The layers may be formed of sheets of material, cords of material, filaments of material, or any other desired arrangement. In other alternative embodiments, the multi-layer tread band may include a layer of extensible material, such as an elastomer. According to one example embodiment, the tread band may include a pair of inextensible layers separated by a layer of extensible material. In still other alternative embodiments, the tread band may include bands that are referred to as shear bands, shear elements, or thin annular high strength band elements.

Support structure 100 connects the lower ring 20 to the upper ring 30. The support structure 100 extends from the external surface 24 of the lower ring 20 and the internal surface 33 of the upper ring 30. The support structure 100 is made up of a plurality of spokes 200. In the illustrated embodiment, the plurality of spokes 200 are arranged into two axially spaced spoke groups, including a first spoke group 202 and a second spoke group 204 axially spaced from the first spoke group 202. In alternative embodiments, the support structure may include more than two axially spaced spoke groups.

As shown in FIG. 3, the first spoke group 202 and the second spoke group 204 spaced apart from one another in the axial direction. In alternative embodiments, the space between the first spoke group and the second spoke group may be larger or smaller, or the first and second spoke groups may be arranged with no space therebetween. When viewed from the perspective shown in FIG. 1, each spoke 200 of the first spoke group 202 is substantially convex relative to a clockwise circumferential direction of the non-pneumatic tire 10, and each spoke of the second spoke group 204 is substantially concave relative to the clockwise circumferential direction of the non-pneumatic tire 10.

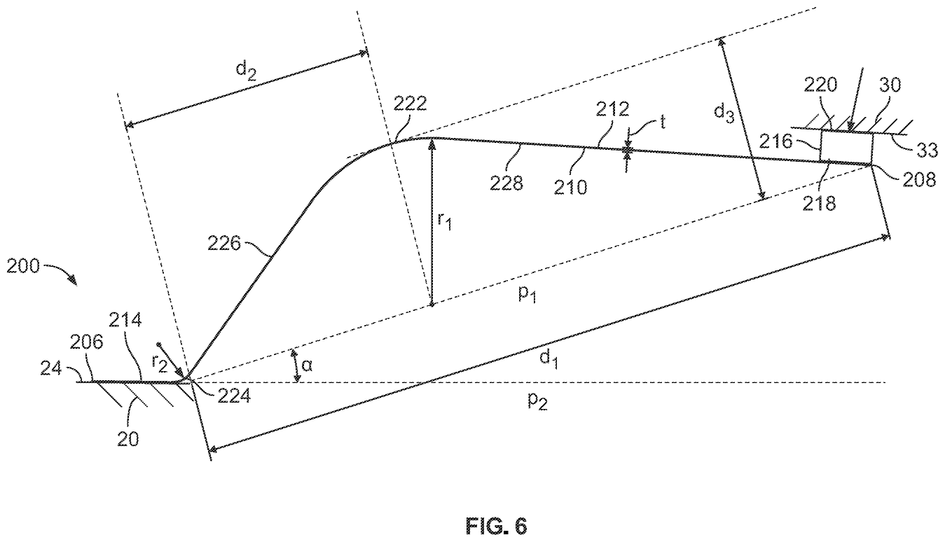

All of the spokes 200 of the first and second spoke groups 202, 204 have the same configuration. Accordingly, the description of the spokes 200 will be made with reference to the single spoke 200 shown in FIG. 6. The spoke 200 may be manufactured out of metals such as steel or aluminum, polymers such as polyester or nylon, composites such as fiberglass or carbon fiber reinforced polymers, or any other desired material or combination of materials. The spoke 200 may be provided with reinforcements (not shown).

The spoke 200 extends between a first end 206 and a second end 208, and has a substantially rectangular cross section that includes a first surface 210 and a second surface 212 facing opposite the first surface 210. A spoke thickness t refers to the distance between the first and second surfaces 210, 212. In the illustrated embodiment, the spoke 200 has a constant thickness between the first end 206 and the second end 208. In alternative embodiments, the thickness of the spoke may vary between the first and second ends. For example, the spoke may have relatively thicker portions at the first and second ends and a relatively thinner portion between the ends. In other alternative embodiments, the spoke may have any desired cross section shape (e.g., circle, diamond, hexagon, etc.) or may have a combination of different cross section shapes.

An integral foot portion 214 is provided toward the first end 206 of the spoke 200. The first surface 210 of the spoke 200 at the foot portion 214 is attached to the external surface 24 of the lower ring 20 to connect the first end 206 of the spoke 200 to the lower ring 20. The foot portion 214 may be attached to the external surface 24 of the lower ring 20 using welding, brazing, soldering, adhesives, mechanical fasteners (e.g., bolts, rivets), key/keyway, or any other desired arrangement. In the illustrated embodiment, the foot portion 214 is substantially straight, and the entire length (dimension of the foot portion extending along the circumferential direction of the tire) and the entire width (dimension of the foot portion extending along the axial direction of the tire) is secured to the external surface 24 of the lower ring 20. In alternative embodiments, the foot portion may be a separate component that is attached to the spoke. In other alternative embodiments, the foot portion may be curved to match the radius of curvature of the external surface of the lower ring or have any other desired curvature. In still other alternative embodiments, only a part or multiple discrete parts of the foot portion may be attached to the external surface of the lower ring. In still yet other alternative embodiments, the foot portion may be attached below the external surface of the lower ring, or the spoke may extend through the lower ring so that the foot portion can be attached to the internal surface of the lower ring.

A flexure member 216 is provided at the second end 208 of the spoke 200. The flexure member 216 has a width that extends along the axial direction of the tire. The flexure member 216 may be manufactured out of a polymer (e.g., urethane or rubber), a thin, curved piece of metal, or any other desired material or combination of materials. In the illustrated embodiment, the flexure member 216 is provided as a rectangular cuboid and arranged so that an end of the flexure member 216 is aligned with the second end 208 of the spoke 200. In other alternative embodiments, the flexure member may be arranged so that an end of the flexure member is set back from the second end of the spoke, or may be arranged so that an end of the flexure member extends beyond the second end of the spoke. In still yet other alternative embodiments, the flexure member may be replaced with a mechanical pinned joint (i.e., hinge).

The flexure member 216 includes a spoke facing surface 218 and a ring facing surface 220. The spoke facing 218 surface of the flexure member 216 is attached to the second surface 212 of the spoke 200 and the ring facing surface 220 is attached to the internal surface 33 of the upper ring 30 to connect the second end 208 of the spoke 200 to the upper ring 30. The attachment between the flexure member 216 and the spoke 200 or between the flexure member 216 and the upper ring 30 may be achieved using welding, brazing, soldering, adhesives, mechanical fasteners (e.g., bolts, rivets), key/keyway, or any other desired arrangement. For example, the attachment may be provided by casting urethane directly against the spoke, with or without the spoke being first coated in a primer.

The flexure member 216 provides flexibility to the connection between the second end 208 of the spoke 200 and the upper ring 30. This flexibility decreases the chances of high stresses being generated within the spoke 200, thereby improving the robustness of the non-pneumatic tire 10. In comparison to the flexible connection provided by the flexure member 216, the connection provided by the foot portion 214 at the first end 206 of the spoke 200 is more rigid.

In alternative embodiments, the flexure member may have a shape or configuration that is different from what is specifically shown and described. In other alternative embodiments, additional structure(s) or mechanism(s) may supplement the flexure member to attach the second end of the spoke to the upper ring. In still other alternative embodiments, the flexure member may be omitted and the second end of the spoke may be directly attached to the upper ring. In these alternative embodiments, the second end of the spoke may be attached directly to the internal surface of the upper ring, above the internal surface of the upper ring, or the spoke may extend through the upper ring so that the second end can be attached to the external surface of the upper ring.

The spoke 200 includes a knee portion 222 between the first end 206 and the second end 208. The knee portion 222 has a first radius of curvature r₁. According to one example embodiment, the first radius of curvature r₁ is 2-6 inches (5-15 cm). When attached to the upper and lower rings 20, 30, the knee portion 222 is concavely curved relative to the lower ring 20.

A transition portion 224 is provided between the knee portion 222 and the first end 206. The transition portion 224 has a second radius of curvature r₂. According to one example embodiment, the second radius of curvature r₂ is 0-2 inches (0-5 cm). When attached to the upper and lower rings 20, 30, the transition portion 224 is convexly curved relative to the lower ring 20. Thus, relative to a single spoke 200, the knee portion 222 and the transition portion 224 are concavely curved in opposite facing directions. In alternative embodiments, the knee portion and the transition portion are concavely (or convexly) curved in the same direction.

The foot portion 214 extends from the transition portion 224 to the first end 206 of the spoke 200. A first connecting portion 226 connects the transition portion 224 to the knee portion 222, and a second connecting portion 228 connects the knee portion 222 to the second end 208 of the spoke 200. In the illustrated embodiment, the first and second connecting portions 226, 228 are both linear. In alternative embodiments, the first connecting portion or the second connecting portion may be curved or have any other desired configuration. In other alternative embodiments, the transition portion and the foot portion may be omitted. In such alternative embodiments, the first end of the spoke would be located at the end of the first connecting portion.

A base plane p₁ intersects the transition portion 224 and the second end 208 of the spoke 200, and serves as a reference for various dimensional aspects of the spoke 200. The angle between the base plane p₁ and a second plane p₂ extending tangentially to the external surface 24 of the lower ring 20 at the transition portion 224 is α. According to one example embodiment, the angle α is +0-20 degrees. The distance between the transition portion 224 and the second end 208 of the spoke 200 along a direction parallel to the base plane p₁ is d₁. According to one example embodiment, the distance d₁ is 10-25 inches (25-63.5 cm). The distance between a center of the transition portion 224 and the center of the first radius of curvature r₁ of the knee portion 222 along a direction parallel to the base plane p₁ is d₂. According to one example embodiment, the value of the distance d₂ is 20-70 percent of the distance d₁. The maximum distance between the knee portion 222 and the base plane p₁ along a direction perpendicular to the base plane p₁ is d₃. According to one example embodiment, the distance d₃ is 2-4 inches (5-10 cm).

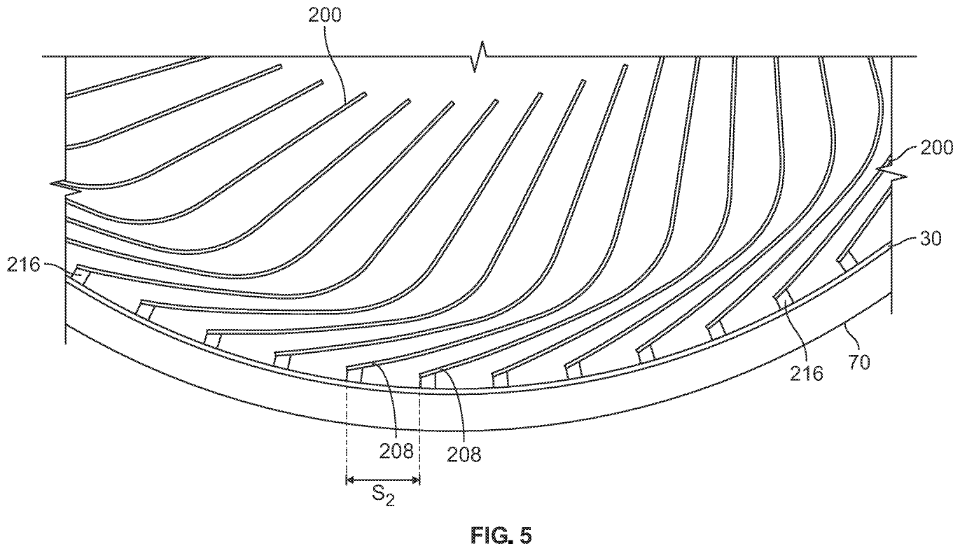

Referring to FIG. 10, the transition portion 224 of one spoke 200 is separated from the first end 206 of an adjacent spoke 200 by a first spacing distance s₁. The second end 208 of adjacent spokes 200 are separated from one another by a second spacing distance s₂ (also see FIG. 5).

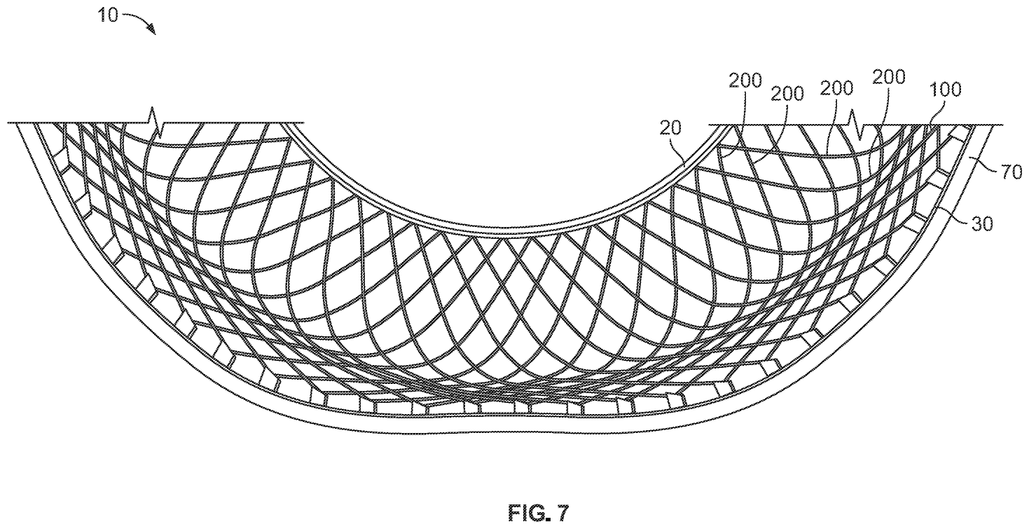

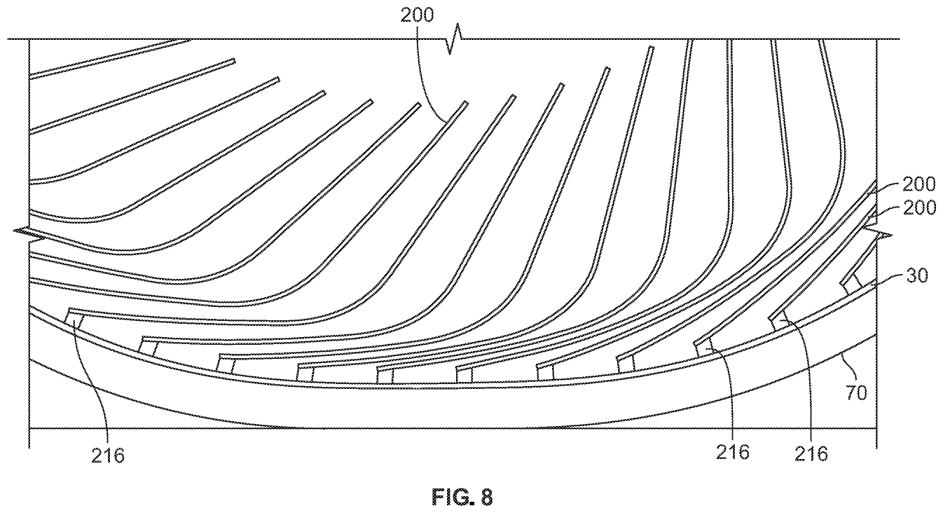

A non-pneumatic tire constructed in accordance with the above described design parameters may provide a more robust assembly, especially in terms of impact performance. FIGS. 7 and 8 shows the tire in an exemplary first condition. As shown FIGS. 7 and 8, according to a non-limiting example, in the first condition the tire 10 is rolling on a flat surface while carrying a load (i.e., normal operation), the non-pneumatic tire 10 deforms, but adjacent spokes 200 are not in contact with one another. The lack of contact between adjacent spokes 200 during normal operation is desirable to avoid the creation of unnecessary stresses in the structure of the non-pneumatic tire 10.

It is expected that the non-pneumatic tire 10 will be exposed to a high impact event during its lifetime, such as hitting a curb, pothole, or other obstruction or road imperfection. During a high impact event, the non-pneumatic tire 10 may deform at significantly higher levels than the deformation that occurs during normal operation. One example of a high impact event is the non-pneumatic tire 10 striking a curb at a low speed (e.g., 6 inch (15 centimeter) curb at 5 miles per hour (8 kilometers per hour)). Another example of a high impact event is the non-pneumatic tire 10 striking a step-up road imperfection at a high speed (e.g., 1 inch (2.5 centimeter) step-up at 70 miles per hour (113 kilometers per hour)). These are merely examples and are not meant to limit the definition of “high impact event.”

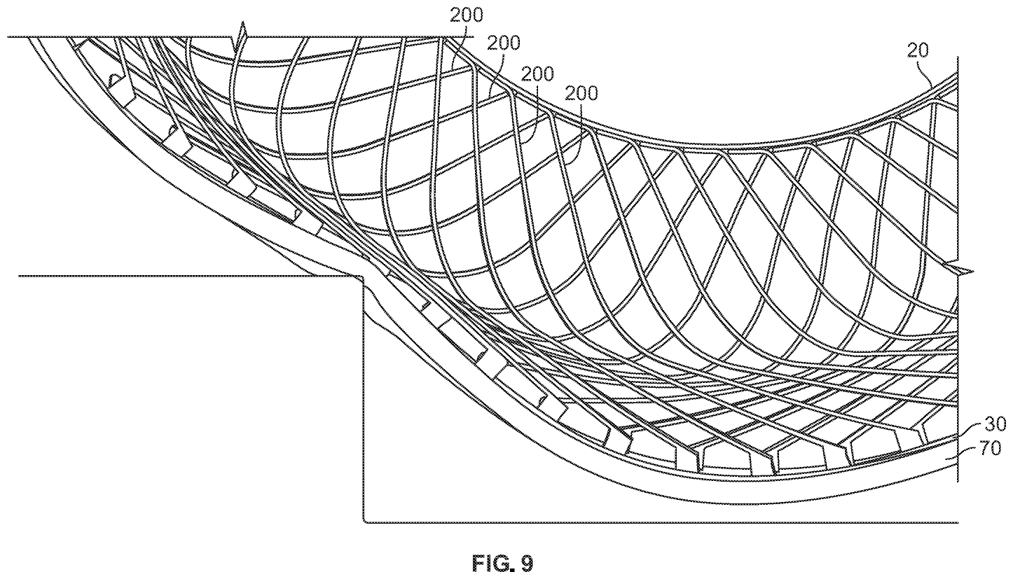

FIGS. 9 and 10 show the tire in an exemplary second condition, the second condition being different from the first condition. As shown in FIGS. 9 and 10, according to a non-limiting example, in the second condition the non-pneumatic tire 10 experiences a high impact event, in which the tire rolls over an uneven surface. According to one non-limiting example, the uneven surface is a road imperfection that protrudes above the ground, or depresses into the ground, a distance of 3 inches (8 cm). According to another non-limiting example, the uneven surface is a road imperfection that protrudes above the ground, or depresses into the ground, a distance of 4.5 inches (11 cm). According to yet another non-limiting example, the uneven surface is a road imperfection that protrudes above the ground, or depresses into the ground, a distance of 6 inches (15 cm).

The non-pneumatic tire 10 responds to the high impact event by deforming so that adjacent spokes 200 contact one another. It has been found that, surprisingly, the contact between adjacent spokes 200 during a high impact event significantly lowers the stress experienced by an individual spoke 200 compared to a non-pneumatic tire where spokes do not contact one another during a high impact event. The reduction of stress in an individual spoke 200 is a result of the contact between the adjacent spokes 200, as the contact distributes the load among multiple spokes 200. In other words, rather than a single spoke 200 absorbing the load arising from the high impact event, multiple spokes 200 share the same load, thus reducing the peak load of any one single spoke 200.

In the illustrated embodiment, the non-pneumatic tire 10 is arranged and configured so that at least three adjacent spokes 200 are in simultaneous contact with one another during a high impact event, and the spokes 200 in contact with one another are located adjacent to the obstruction or road imperfection responsible for the high impact event. In alternative embodiments, the non-pneumatic tire may be arranged and configured to have a fewer or greater number of adjacent spokes in simultaneous contact with one another during a high impact event. In other alternative embodiments, the adjacent spokes in simultaneous contact with one another may be located at any location along the circumferential direction of the tire (i.e., spaced away from the obstruction or road imperfection responsible for the high impact event).

Design parameters of the spokes 200 and other components of the non-pneumatic tire 10 may be altered to provide the non-pneumatic tire 10 with desired performance characteristics. Preferably, these design parameters are selected so that contact between adjacent spokes 200 occurs before the spoke 200 begins to yield or experience any other forms of damage.

The maximum distance d₃ between the knee portion 222 and the base plane p₁ along a direction perpendicular to the base plane p₁, affects spoke stiffness and when contact between adjacent spokes 200 will occur. Increasing the distance d₃ will physically move each spoke 200 closer to adjacent spokes 200, thus causing contact between adjacent spokes 200 to occur relatively sooner. Additionally, increasing the distance d₃ will decrease the stiffness of the spoke 200, thus increasing the amount deflection for a given load, which increases the likelihood of contact between adjacent spokes 200. Decreasing the distance d₃ will have an opposite effect, and will physically move each spoke 200 farther from adjacent spokes 200, thus causing contact between adjacent spokes 200 to occur relatively later. Additionally, decreasing the distance d₃ will increase the stiffness of the spoke 200, thus decreasing the amount of deflection for a given load, which decreases the likelihood of contact between adjacent spokes 200.

The distance d₂ between the transition portion 224 and the center of the first radius of curvature r₁ of the knee portion 222 along a direction parallel to the base plane p₁, affects when contact with adjacent spokes 200 will occur. When the distance d₂ is a greater percentage of d₁, this will result in contact between adjacent spokes 200 occurring relatively sooner. When the distance d₂ is a smaller percentage of d₁, this will result in contact between adjacent spokes 200 occurring relatively later.

The radius of curvature r₁ of the knee portion 222, affects when contact with adjacent spokes 200 will occur. Decreasing the radius of curvature r₁ will result in contact between adjacent spokes 200 occurring relatively later, while increasing the radius of curvature r₁ will result in contact between adjacent spokes 200 occurring relatively sooner. The spoke thickness t affects the stiffness of the spoke 200. Increasing spoke thickness t will increase the stiffness of the spoke 200, while decreasing spoke thickness will decreases the stiffness of the spoke 200.

Additionally, it has been found that vertical stiffness of the tire is affected by the combination of spoke thickness t and the distance d₃. Increasing the distance d₃ decreases tire stiffness, while decreasing the distance d₃ increases tire stiffness. Consequently, it has been found that, in order to meet a targeted value of tire stiffness, a spoke with a larger thickness t should be combined with a larger distance d₃, while a spoke with a smaller thickness t should be combined with a smaller distance d₃.

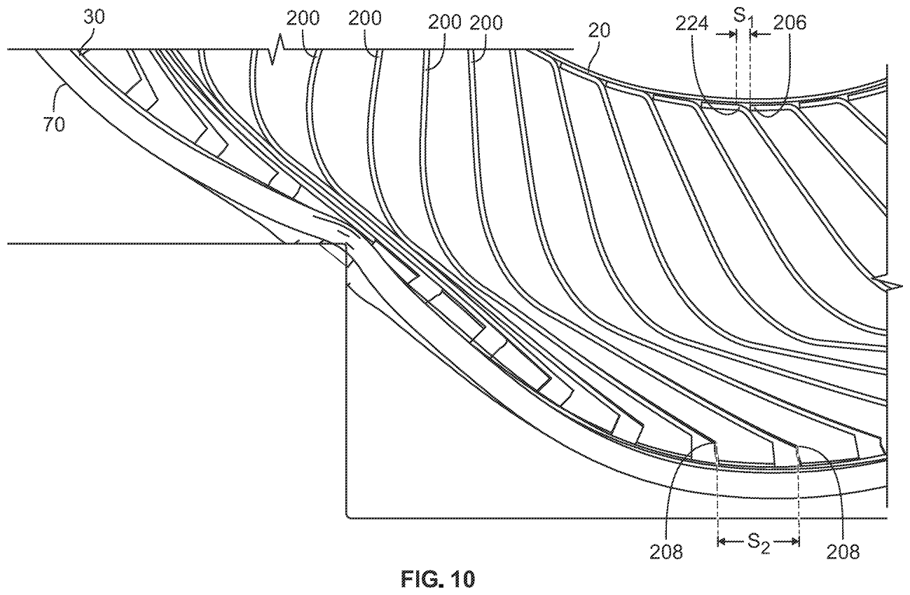

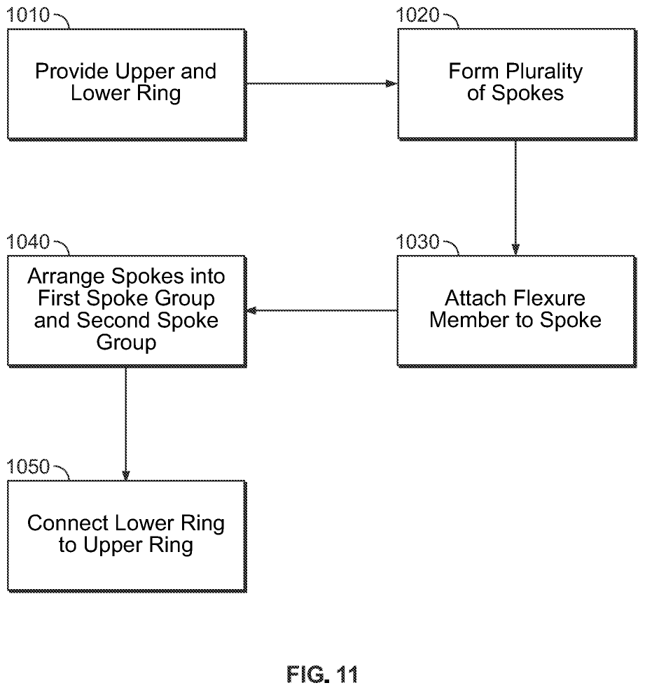

FIG. 11 is a flow chart showing an exemplary method of manufacturing a non-pneumatic tire. At 1010, a lower ring and an upper ring are provided. The lower ring has a first diameter and the upper ring has a second diameter that is greater than the first diameter. At 1020, a plurality of spokes are formed. The spokes may be formed using hot stamping, cold forming, extruding, rolling, bending, or any other desired method. Additionally, the spokes may be formed using multiple composite fabrication techniques (e.g., resin transfer molding and high pressure resin transfer molding). Further examples of methods for forming the spokes include wet lay-up, prepreg lamination. Each spoke extends between a first end and a second end. A knee portion is located between the first end and the second end, and a transition portion is located between the first end and the knee portion. The knee portion and the transition portion are concavely curved in opposite facing directions. A foot portion extends from the transition portion.

At 1030, a flexure member is attached to the spoke. At 1040, the spokes are arranged into a first spoke group and a second spoke group that is axially spaced from the first spoke group. Furthermore, the plurality of spokes of the first spoke group are arranged to be concavely curved relative to a first circumferential direction of the tire, and the plurality of spokes of the second spoke group are arranged to be convexly curved relative to the first circumferential direction of the tire.

At 1050, the lower ring is connected to the upper ring using the first spoke group and the second spoke group. The foot portion of each of the spokes is attached to the lower ring to connect the first end of each spoke to the lower ring. The flexure member is attached to the upper ring to connect the second end of each spoke to the upper ring.

In alternative embodiments, the foregoing steps may occur in an order other than what is specifically described. In other alternative embodiments, the method may include a greater or fewer number of steps.

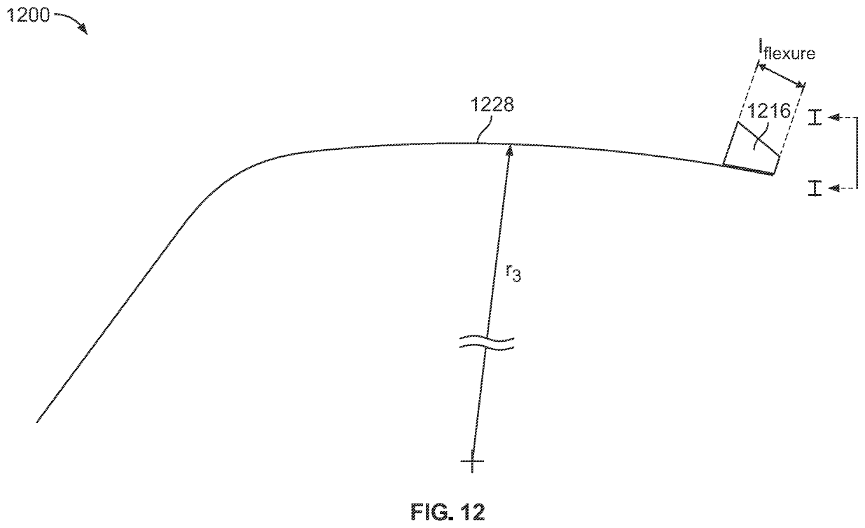

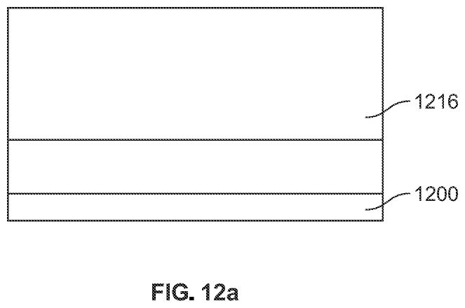

FIGS. 12 and 12a show another embodiment of a spoke 1200. The spoke 1200 of FIGS. 12 and 12a is substantially the same as the spoke 200 in FIGS. 1-10, except for the differences described herein. Accordingly, like features will be identified by like numerals increased by a factor of “1000.” In the spoke 200 shown in FIGS. 1-10, the second connecting portion 228 is linear. In comparison, the spoke 1200 of FIGS. 12 and 12a has a curved second connecting portion 1228 with a radius of curvature r₃. In comparison to a linear second connecting portion, the curved second connecting portion 1228 in the spoke 1200 of FIGS. 12 and 12a significantly enhances self-supporting behavior. According to one example embodiment, the radius of curvature r₃ is 10-50 inches (25-127 cm).

In addition to the design parameters and resultant changes in performance characteristics discussed above in regard to the spoke 200 shown in FIGS. 1-10, the radius of curvature r₃ of the curved second connecting portion 1228 in the spoke 1200 of FIGS. 12 and 12a can be varied to affect performance. The radius of curvature r₃ of the curved second connecting portion 1228 and a length l_{flexure} of the flexure member 1216 interact to affect self-supporting performance. A smaller radius of curvature r₃ of the curved second connecting portion 1228 decreases self-supporting, thus increasing stress during high impact events. A larger radius of curvature r₃ of the curved second connecting portion 1228 increases self-supporting, thus decreasing stress during high impact events. This decrease in stress, however, occurs only up to a point. As the radius of curvature r₃ increases (the limit being the radius of curvature r₃ equal to infinity, resulting in a straight second connecting portion), the effectiveness of the self-supporting begins to once again decrease.

The length l_{flexure} of the flexure member 1216 affects its ability to exert torque at the end of the spoke 1200. This torque acts to straighten the curved second connecting portion 1228 as the tire rolls under a normal load or experiences a high impact event. Consequently, it has been found that a curved second connecting portion 1228 with a smaller radius of curvature r₃ is optimally matched with a flexure member 1216 having a longer length l_{flexure}, while a curved second connecting portion 1228 with a larger radius of curvature r₃ is optimally matched with a flexure member 1216 having a shorter length l_{flexure}. The ability of the flexure member 1216 to exert torque on the spoke 1200 is, in addition to the length l_{flexure} of the flexure member 1216, affected by the stiffness of the material used to manufacture the flexure member 1216. Consequently, it is desirable to provide a flexure member 1216 with a longer length l_{flexure} when a softer material is used, and to provide a flexure member 1216 with a shorter length l_{flexure} when a stiffer material is used.

The non-pneumatic tire described herein improves the robustness of the non-pneumatic tire by providing an arrangement where adjacent spokes contact one another during a high impact event. The contact between adjacent spokes results in multiple spokes sharing a load, thus significantly reducing the stress experienced by any single spoke in the non-pneumatic tire. Thus, the durability of the non-pneumatic tire is improved.

As described above, the foot portion 214 connects the first end 206 of the spoke 200 to the lower ring 20 and the flexure member 216 connects the second end 208 of the spoke 200 to the upper ring 30. The flexure member 216 provides a comparatively flexible connection between the second end 208 of the spoke 200 and the upper ring 30, whereas the foot portion 214 provides a comparatively rigid connection between the first end 206 of the spoke 200 and the lower ring 20.

According to this embodiment, the spoke 200 exhibits behavior akin to a cantilevered beam, whereby the second end 208 deflects (i.e., moves) relative to the first end 206 as the tire 10 rolls and deforms. While this behavior is not inherently undesirable, it does cause the spoke 200 to compress, stretch, or shear, thereby creating stresses in the spoke 200. It has been found that maximum stresses occur toward the first end 206 of the spoke, specifically near where the attachment between the foot portion 214 and the lower ring 20 ends, extending through the transition portion 224, and part way through the first connecting portion 226.

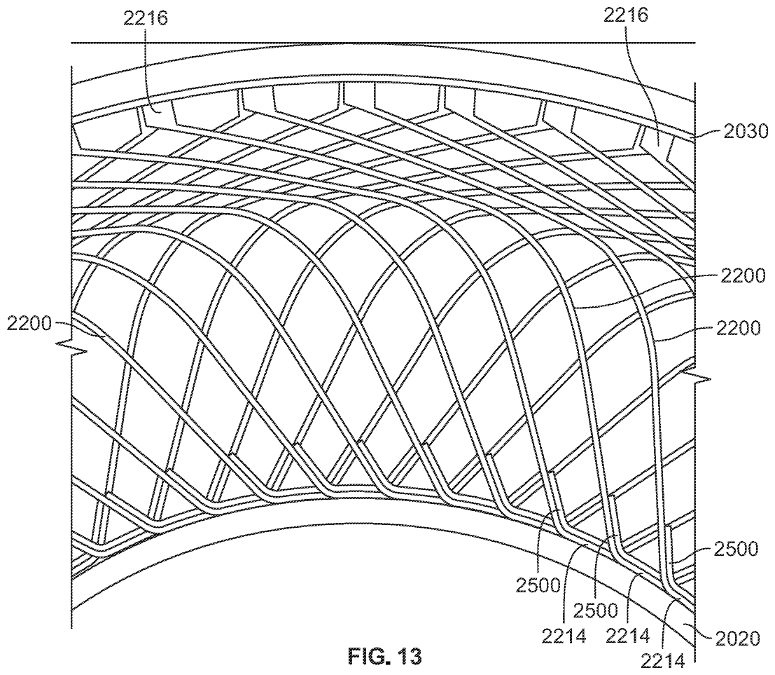

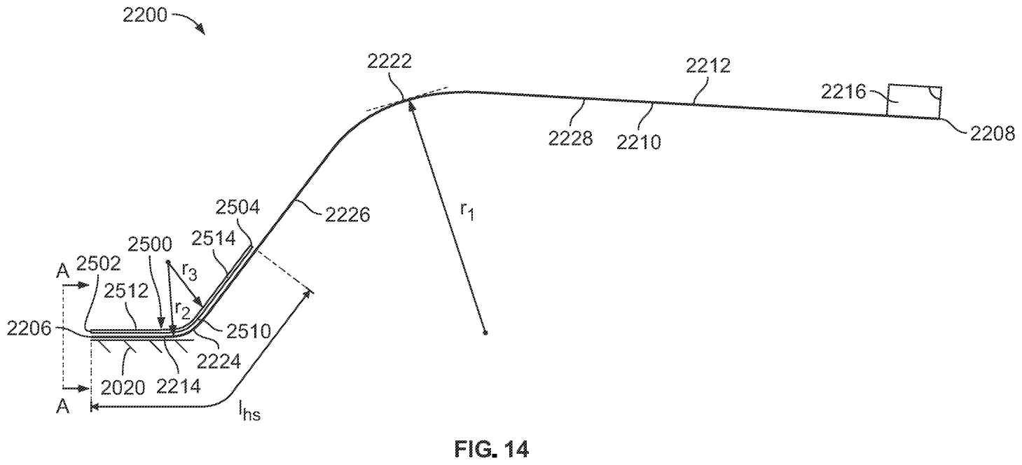

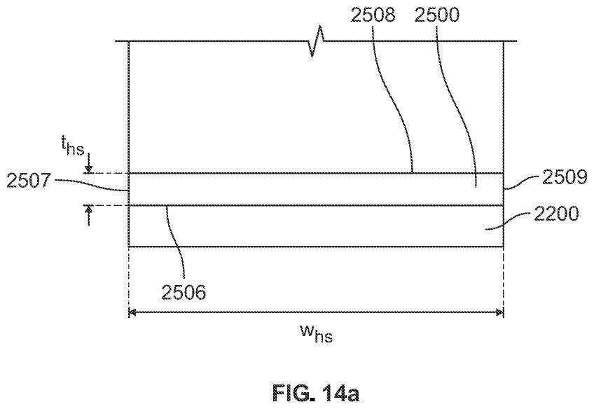

FIGS. 13-15 show an alternative non-pneumatic tire with spokes 2200 having features designed to attenuate the above-identified stresses. The embodiment shown in FIGS. 13-15 is substantially similar to the embodiment shown in FIGS. 1-6, except for any differences described herein. Accordingly, like features will be identified by like numerals increased by a value of “2000.”

Each spoke 2200 has first and second surfaces 2210, 2212 that each extend between a first end 2206 and a second end 2208. A foot portion 2214 is provided toward the first end 2206 of the spoke 2200. A flexure member 2216 is provided at the second end 2208 of the spoke 2200. The foot portion 2214 is attached to the lower ring 2020 to connect the first end 2206 of the spoke 2200 to the lower ring 2020, and the flexure member 2216 is attached to the upper ring 2030 to connect the second end 2208 of the spoke 2200 to the upper ring 2030.

A knee portion 2222 is provided between the first end 2206 and the second end 2208. The knee portion 2222 has a first radius of curvature r₁. A transition portion 2224 is provided between the knee portion 2222 and the first end 2206, with the foot portion 2214 extending from the transition portion 2224 toward the first end 2206. The transition portion 2224 has a second radius of curvature r₂. A first connecting portion 2226 connects the transition portion 2224 to the knee portion 2222. A second connecting portion 2228 connects the knee portion 2222 to the second end 2208 of the spoke 1200.

In this embodiment, the spoke 2200 is provided with a helper spring 2500. The helper spring 2500 may be manufactured out of metal (e.g., steel, stainless steel, titanium), composites (e.g., carbon fiber reinforced polymer, glass reinforced polymer), or any other desired material or combination of materials. The helper spring 2500 may be provided with reinforcements (not shown) or other features that affect the helper spring's stiffness. In the illustrated embodiment, the helper spring 2500 is a separate, discrete component from the spoke 2200. In alternative embodiments, the helper spring may be formed integrally with the spoke by, for example, folding an end of the spoke back onto itself.

The helper spring 2500 extends between a first end 2502 and a second end 2504, and has a substantially rectangular cross section that includes oppositely facing first and second surfaces 2506, 2508. A helper spring length Ins refers to the overall distance between the first end 2502 and the second end 2504 as measured along a longitudinal axis of the helper spring 2500. A helper spring width wₕₛ, refers to a distance between first and second edges 2507, 2509 of the helper spring 2500 along a direction extending transverse to its length lₕₛ. A helper spring thickness this refers to the distance between the first and second surfaces 2506, 2508. In the illustrated embodiment, the helper spring thickness tₕₛ is constant between the first end 2502 and the second end 2504, and is equal to the thickness t₁ of the spoke 2000. Additionally, the helper spring helper spring width wₕₛ is constant between the first end 2502 and the second end 2504, and is equal to a width of the spoke 2000. In alternative embodiments, the thickness or width of the helper spring may vary between the first end and the second end, or the helper spring and the spoke may have different thicknesses or widths. In other alternative embodiments, the helper spring may have any desired cross section shape or may have a combination of different cross section shapes.

The helper spring 2500 has a curved portion 2510 between the first end 2502 and the second end 2504. In the illustrated embodiment, the curved portion 2510 has a radius of curvature r₃ that is substantially equal to the radius of curvature r₂ of the transition portion 2224 of the spoke 2000. In alternative embodiments, the curved portion may have a radius of curvature that is different from the radius of curvature of the transition portion.

A first arm portion 2512 connects the first end 2502 to the curved portion 2510. A second arm portion 2514 connects the second end 2504 to the curved portion. In the illustrated embodiment, the first and second arm portions 2512, 2514 are both linear In alternative embodiments, the first arm portion or the second arm portion may be curved or have any other desired arrangement.

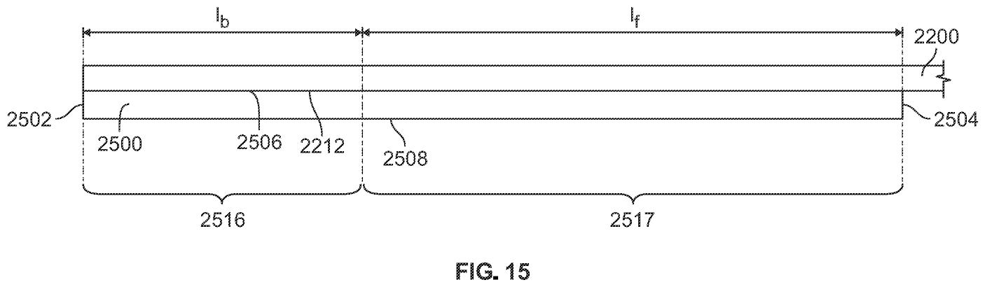

As best shown in FIG. 15, the first surface 2506 of the helper spring 2500 is attached to the second surface 2212 of the spoke 2200 along a bond region 2516. The helper spring 2500 may be attached to the spoke 2200 using welding, brazing, soldering, adhesives, mechanical fasteners, or any other desired attachment method. According to this embodiment, the helper spring 2500 is radially located above the spoke 2200 (i.e., a radial distance between the helper spring and the lower ring is greater than a radial distance between the spoke and the lower ring).

In the illustrated embodiment, the bond region 2516, beginning at the first end 2502 of the helper spring 2500, has a bond length l_{b} that extends continuously along 33% of the length Ins of the helper spring 2500 and the entire width wₕₛ of the helper spring. The portion of the helper spring 2500 that is not bonded to the spoke 2200 is referred to as a free portion 2571 and has a free length l_{f}. In alternative embodiments, the bond region may extend along 20-100% length of the helper spring or 20-100% width of the helper spring. In other alternative embodiments, the bond region may not begin at the first end of the helper spring but, instead, there may be an unbonded region of any desired length before the start of the bond region. In still other alternative embodiments, the bond region may be intermittently provided along the length of the helper spring.

The helper spring 2500 is arranged relative to the spoke 2200 so that the curved portion 2510 of the helper spring 2500 is adjacent to and nests with the transition portion 2224 of the spoke 2200. In the illustrated embodiment, the first arm portion 2512 of the helper spring 2500 is dimensioned and configured so that the first end 2502 of the helper spring 2500 is aligned with the first end 2206 of the spoke 2200, and the second arm portion 2514 is dimensioned and configured so that the second end 2504 of the helper spring 2500 is located slightly less than midway between the transition portion 2224 and the knee portion 2222 of the spoke 2200. In alternative embodiments, the first or second arm portions may be dimensioned and configured to locate the first or second ends of the helper spring at any desired location relative to the spoke.

It has been found that the provision of the helper spring 2500 significantly reduces the maximum stresses that occur during spoke 2200 compression. Design parameters of the helper spring 2500, the spoke 2200, and other components of the non-pneumatic tire may be altered to provide the non-pneumatic tire with desired performance characteristics. For example, increasing the length of the second arm portion 2514 of the helper spring 2500 reduces maximum stresses that occur in the spoke 2200, but may create greater contact pressure between the helper spring 2500 and the spoke 2200. As another example, increasing the thickness of the helper spring 2500 reduces maximum stresses that occur in the spoke 2200, but may increase contract pressure between the helper spring 2500 and the spoke 2200. Additionally, increasing the thickness of the helper spring 2500 may increase stress in the bond region 2516.

In the illustrated embodiment, the spoke arrangement includes only a single helper spring 2500. In alternative embodiments, the spoke arrangement may include a plurality of helper springs. In one example embodiment, each one of the plurality of helper springs is identical to one another. In other example embodiments, each one of the plurality of helper springs may have different lengths, thicknesses, widths, or be made out of different materials or have different reinforcements, or may have other design variables that are selected to provide the non-pneumatic tire with desired performance characteristics.

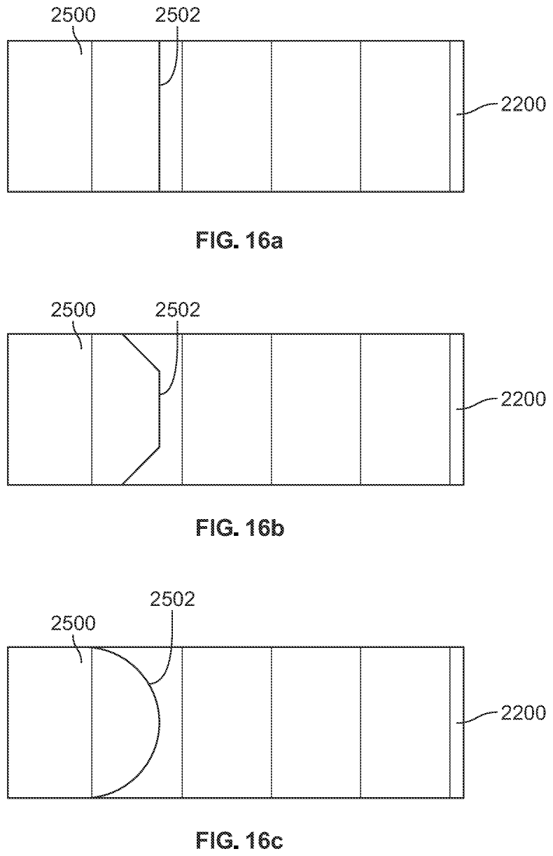

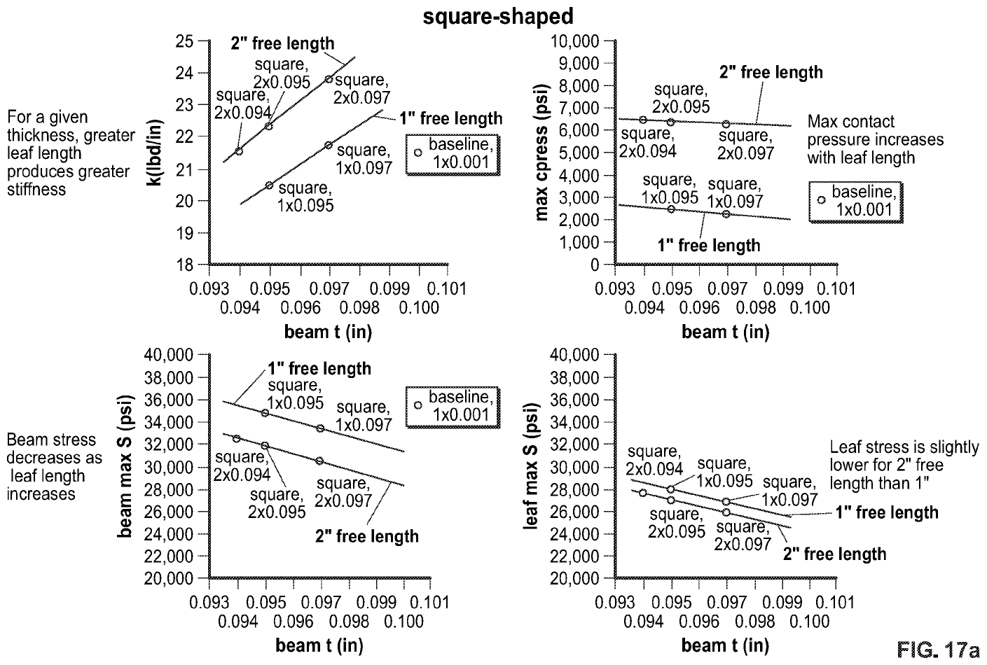

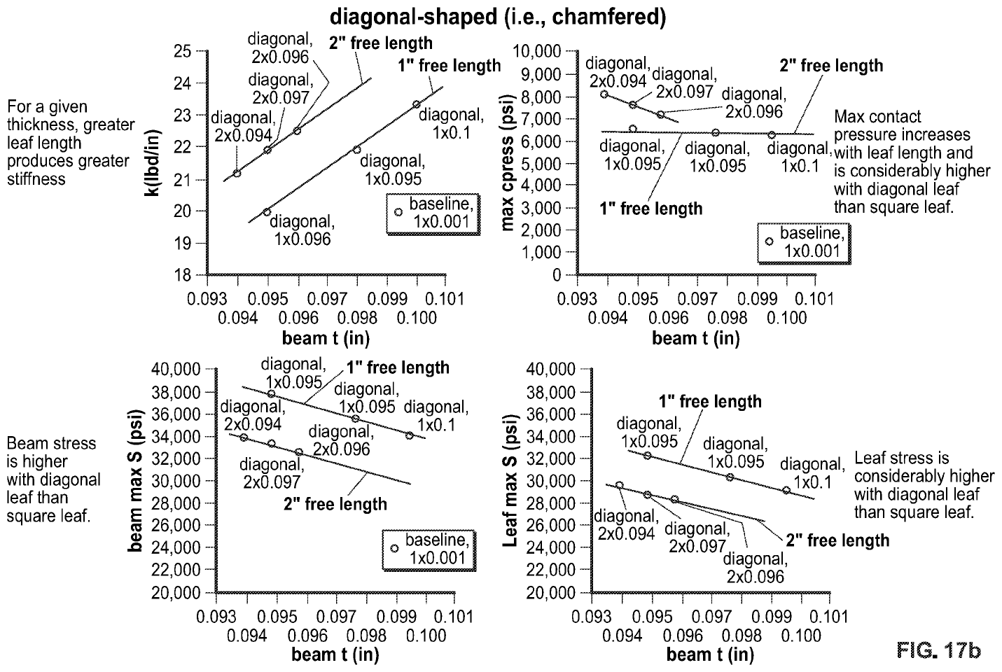

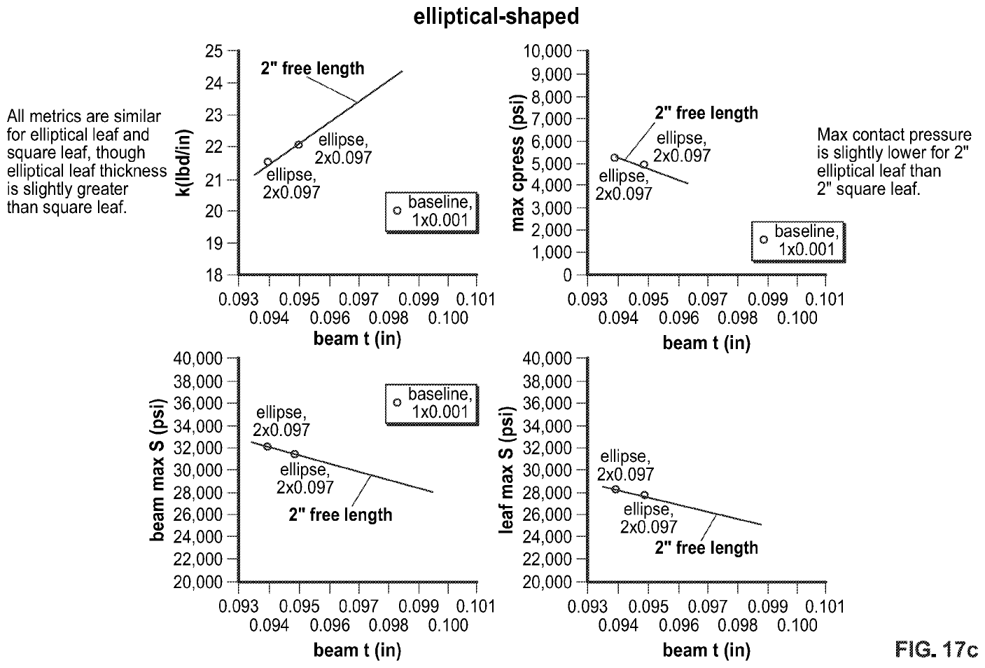

In addition to the design variables described above, the second end 2504 of the helper spring 2500 may be provided as various plan shapes or with specific edge arrangements to further tune the spoke 2200 and provide desired non-pneumatic tire performance characteristics. FIGS. 16a-c show three variants for the plan shape of the second end 2502 of the helper spring 2500, and FIGS. 17a-c are graphs showing performance metrics associated with each design variation. In FIG. 16a, the second end 2502 of the helper spring 2500 is square-shaped in plan view. It has been found that this square shape allows the whole helper spring 2500 to evenly support the spoke 2200, and results in the performance metrics shown and described in FIG. 17a. Additionally, it has been found that the square shape provides the greatest stress reduction in the spoke 2200. In FIG. 16b, the second end 2502 of the helper spring 2500 has beveled corners in plan view. It has been found that using angled corners instead of square corners reduces contact pressure between the helper spring 2500 and the spoke 2200, and results in the performance metrics shown and described in FIG. 17b. Additionally, it has been found that the diagonal shape may improve fatigue performance of the spoke 2200. In FIG. 16c, the second end 2502 of the helper spring 2500 is elliptical-shaped in plan view. It has been found that this elliptical shape provides reduced stress reduction similar to the square-shaped end while also reducing contract pressure similar to the beveled corner design, and results in the performance metrics shown and described in FIG. 17c.

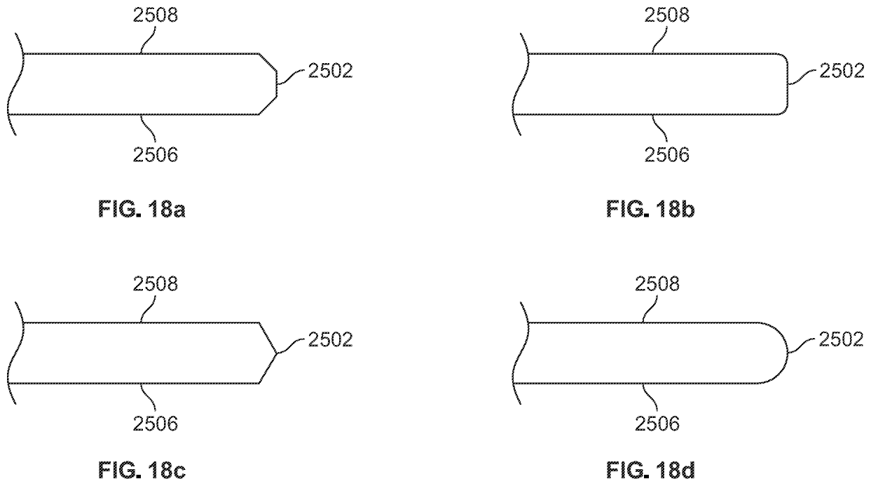

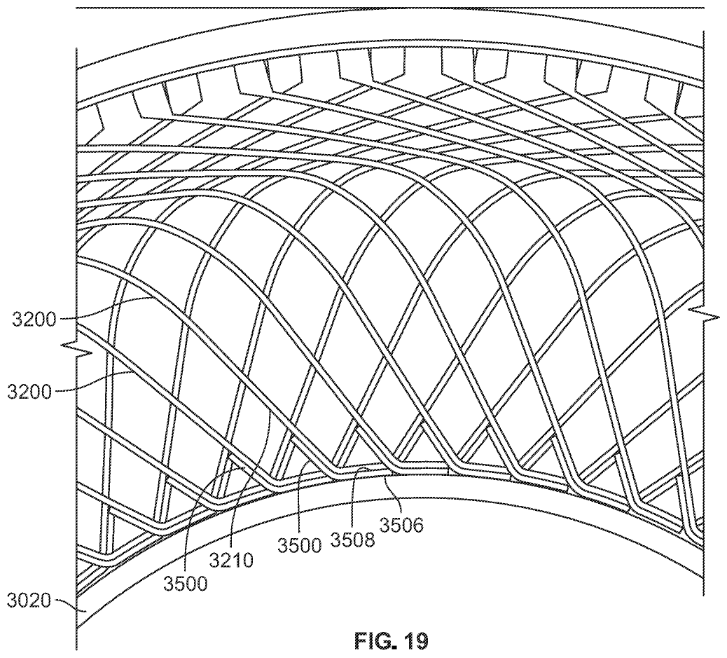

FIGS. 18a-18d show four variants for the edge shape of the second end 2502 of the helper spring 2500. Here, “edge” refers to the surface of the helper spring 2500 at the second end 2502 that connects the first surface 2506 to the second surface 2508. In FIG. 18a, the second end 2502 of the helper spring 2500 has a chamfered upper portion and a chamfered lower portion with a straight portion extending therebetween. When attached to the spoke 2200, the lower portion is adjacent to the second surface 2212 of the spoke 2200. This arrangement may reduce local contact stress or propensity for fretting damage to occur by reducing local contact stress. In FIG. 18b, the second end 2502 of the helper spring 2500 has a rounded upper portion and a rounded lower portion with a straight portion extending therebetween. This arrangement may reduce the propensity for the occurrence of fretting damage even further than the above-described chamfered design. In FIG. 18c, the upper and lower portions are chamfered such that the entire second end 2502 is angled. In other words, there is no straight portion between the chamfered upper and lower portions. This arrangement may provide similar reductions in local stress and fretting damage similar to the arrangement shown in FIG. 18a. In FIG. 18d, the upper and lower portions are rounded such that the entire second end 2502 is curved. In other words, there is no straight portion between the rounded upper and lower edges. This arrangement may even further reduced stress over the arrangement shown in FIG. 18b.

FIG. 19 shows a variant of the spoke arrangement of FIGS. 12-14. The spoke arrangement of FIG. 18 is substantially similar to the spoke arrangement of FIGS. 12-14, except for any differences described herein. Accordingly, like features will be identified by like numerals increased by a value of “1000.”

According to the variant shown in FIG. 19, the second surface 3508 of the helper spring 3500 is attached to the first surface 3210 of the spoke 3200, and the second end 3208 of the spoke 3200 is attached to the lower ring 3020 by attaching the first surface 3506 of the helper spring 3500 to the lower ring 3020. According to this embodiment, the helper spring 3500 radially is located below the spoke 3200 (i.e., a radial distance between the helper spring and the lower ring is less than a radial distance between the spoke and the lower ring). Locating the helper spring 3500 radially below the spoke 3200 may improve load carrying efficiency due to tension or shear forces. In another variant (not shown), two helper springs may be attached to the spoke, with a first helper spring being attached to the second surface of the spoke and second helper spring being attached to the first surface of the spoke (i.e., one helper spring located above the spoke and one helper spring located below the spoke).

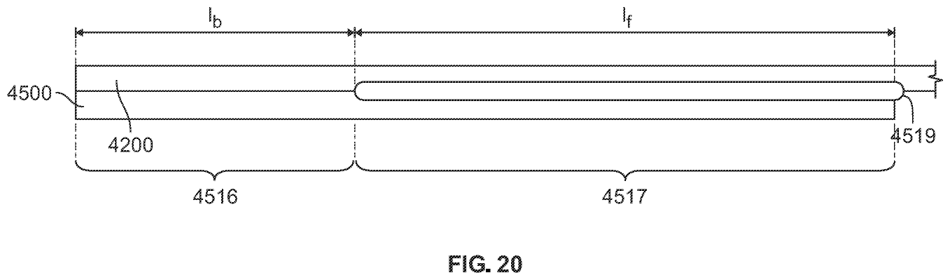

FIG. 20 shows another variant of the spoke arrangement of FIGS. 12-14. The arrangement of FIG. 20 is substantially similar to the arrangement of FIGS. 12-14 except for any differences described herein. Accordingly, like features will be identified by like numerals increased by a value of “4000.”

According to the variant shown in FIG. 20, a buffer 4519 is provided between the helper spring 4500 and the spoke 4200, specifically between the free portion 4517 of the spoke 4200 adjacent the bond region 4516. The buffer 4519 is arranged and configured to minimize the occurrence of stress-induced damage as a result of any contact between the helper spring 4500 and the spoke 4200. In the illustrated embodiment, the buffer 4500 is a separate component from both the helper spring 4500 and the spoke 4200, and may be manufactured out of plastic, metal, carbon fiber reinforced polymer, glass reinforced polymer, ceramics, or any other desired material or combination of materials. The buffer 4519 may be attached to the helper spring 4500 or the spoke 4200 using adhesive, mechanical fasteners, brazing, soldering, welding, or any other desired arrangement. In alternative embodiments, the buffer may be integrated directly into the helper spring or the spoke. In other alternative embodiments, the buffer may be a coating that is applied to the spoke or the helper spring. In still other embodiments, the buffer may be a thin air gap. According to one example, the air gap is 0.0020 inches (0.05 mm) thick.

While different embodiments and variants have been shown and described in the various figures, the disclosed features are not exclusive to each described embodiment. Instead, various features from the different embodiments or variants can be combined as desired.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A non-pneumatic tire comprising:
a lower ring having a first diameter
an upper ring having a second diameter, the upper ring being substantially coaxial with the lower ring; and
a support structure connecting the lower ring to the upper ring, the support structure being made up of a plurality of spokes, the plurality of spokes being arranged into a first spoke group and a second spoke group that is axially spaced from the first spoke group, each one of the plurality of spokes comprising:
a first end connected to the lower ring;
a second end connected to the upper ring;
a transition portion located between the first end and the second end; and
a helper spring nesting with the transition portion of the spoke.

2. The non-pneumatic tire of claim 1, wherein the helper spring is located radially above the spoke.

3. The non-pneumatic tire of claim 1, wherein the helper spring is located radially below the spoke.

4. The non-pneumatic tire of claim 1, wherein the helper spring includes a curved portion between a first end and a second end, and wherein a radius of curvature of the curved portion is substantially equal to a radius of curvature of the transition portion of the spoke.

5. The non-pneumatic tire of claim 1, wherein the helper spring is attached to the spoke along a bond region, the bond region extending along 20%-100% of the length of the helper spring.

6. The non-pneumatic tire of claim 1, wherein the spoke further includes a knee portion located between the transition portion and the second end, and wherein the helper spring includes a first end and a second end, the first end of the helper spring being aligned with the first end of the spoke, the second end of the helper spring being located less than midway between the transition portion and the knee portion of the spoke.

7. The non-pneumatic tire of claim 1, wherein the helper spring includes a curved portion between a first end and a second end, the curved portion being adjacent the transition portion of the spoke, the second end being one of square-shaped, beveled, and elliptical-shaped in plan view.

8. The non-pneumatic tire of claim 1, wherein the helper spring includes a curved portion between a first end and a second end, an edge of the second end being one of square, chamfered, and rounded.

9. The non-pneumatic tire of claim 1, wherein at least one spoke comprises a buffer between the helper spring and the spoke.

10. The non-pneumatic tire of claim 9, wherein the buffer is made up of at least one of plastic, metal, carbon fiber reinforced polymer, glass reinforced polymer, and ceramics.

11. A method of manufacturing a non-pneumatic tire comprising the steps of:
providing a lower ring having a first diameter and an upper ring having a second diameter that is greater than the first diameter;
forming a plurality of spokes, each spoke extending between a first end and a second end, each spoke having a transition portion between the first end and the second end, each spoke having a helper spring nesting with the transition portion;
arranging the plurality of spokes into a first spoke group and a second spoke group that is axially spaced from the first spoke group; and
connecting the lower ring to the upper ring with the first spoke group and the second spoke group.

12. The method of manufacturing a non-pneumatic tire of claim 11, wherein the forming the plurality of spokes involves at least one of hot stamping, cold forming, extruding, and composite lay-up.

13. The method of manufacturing a non-pneumatic tire of claim 11, further comprising the step of forming an end of the helper spring with one of a square shape, a bevel, and an elliptical shape in plan view.

14. The method of manufacturing a non-pneumatic tire of claim 11, further comprising the step of forming an end of the helper spring with one of a square end, a chamfered end, and a rounded end.

15. The method of manufacturing a non-pneumatic tire of claim 11, further comprising providing a buffer between the spoke and the helper spring.

16. A non-pneumatic tire comprising:
a lower ring having a first diameter
an upper ring having a second diameter, the upper ring being substantially coaxial with the lower ring; and
a support structure connecting the lower ring to the upper ring, the support structure being made up of a plurality of spokes, each one of the plurality of spokes being provided with a helper spring nesting with a curved portion of the spoke, the helper spring being arranged and configured to reduce stress in an associated spoke.

17. The non-pneumatic tire of claim 16, wherein at least three adjacent spokes of the plurality of spokes are in simultaneous contact with one another upon the occurrence of the high impact event.

18. The non-pneumatic tire of claim 16, wherein the plurality of spokes are arranged into a first spoke group and a second spoke group that is axially spaced from the first spoke group.

19. The non-pneumatic tire of claim 18, wherein the spokes of the first spoke group are concavely curved relative to a first circumferential direction of the tire, and the spokes of the second spoke group are convexly curved relative to the first circumferential direction of the tire.

20. The non-pneumatic tire of claim 16, wherein each one of the plurality of spokes comprises:
a first end connected to the lower ring;
a second end connected to the upper ring;
a knee portion located between the first end and the second end, the knee portion being concavely curved relative to the lower ring; and
a transition portion located between the first end and the knee portion, the transition portion being convexly curved relative to the lower ring.
